(19) United States
(12) Patent Application Publication
(10) Pub. No.: US 2015/0201580 A1
(43) Pub. Date: Jul. 23, 2015

(54) Pet Carrier With Geometric-shaped Porthole Window

(71) Applicants: Tom Stevenson, Metuchen, NJ (US); Jingmei Liu, Metuchen, NJ (US)

(72) Inventors: Tom Stevenson, Metuchen, NJ (US); Jingmei Liu, Metuchen, NJ (US)

(21) Appl. No.: 14/162,178

(22) Filed: Jan. 23, 2014

(51) Int. Cl. A01K 1/02

(52) U.S. Cl. CPC A01K 1/0254

(57) ABSTRACT

An apparatus used for the transportation of a pet comprising a housing for a pet, with a transparent true dome shaped porthole window molded from a piece of glass, plastic, or other suitable transparent material, having an outwardly directed lip at the base of the dome which is then used to be attach to the apparatus. The transparent true dome shaped porthole window is of a size slightly larger than that of the pet's head and provides a place for the pet to place its head, and allows a greater degree of visibility and protection for the pet. Almost automatically the pet will place its head into the transparent true dome shaped porthole window upon being placed into the apparatus for transportation.

### CROSS-REFERENCE TO RELATED APPLICATIONS

U.S. Patent Documents:

| | | | |
|---|---|---|---|
| D. 694,961 S1 | December 2013 | Skaggs | 119/452 |
| 8,459,208 B2 | June 2013 | Chou | 119/497 |
| 4,977,857 A | December 1990 | Slawinski | 119/497 |
| 6,286,462 B1 | September 2001 | Burns | 119/497 |
| 6,446,577 B1 | September 2002 | Salahor | 119/497 |
| 2006/0288953 A1 | December 2006 | Bottorff | 119/497 |
| 2009/0205578 A1 | August 2009 | Alves | 119/454 |
| 2009/0314219 | December 2009 | Bryson | 119/496 |
| 2010/0175633 A1 | July 2010 | Krauss et al. | 119/497 |
| 2011/0056441 A1 | March 2011 | Chang | 119/453 |
| 2012/0174870 A1 | July 2012 | Grabois | 119/253 |
| 8,584,618 B1 | November 2013 | Babson et al. | 119/496 |

### STATEMENT REGARDING FEDERALLY SPONSORED RESEARCH OR DEVELOPMENT

This invention is not made with government support or under any government contract awarded by any Federal agency. The government does not have certain rights in the invention.

### NAMES OF THE PARTIES TO A JOINT RESEARCH AGREEMENT

None.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

None.

### STATEMENT REGARDING PRIOR DISCLOSURES BY THE INVENTOR OR A JOINT INVENTOR

None.

### BACKGROUND OF THE INVENTION

(1) Field of Invention (“Technical Field”)

The present invention relates generally to the field of pet carriers and more specifically the present invention relates to the ability of a pet to comfortably place its head into a true dome shaped porthole window view the outside from its pet carrier.

(2) Description of Related Art including Information Disclosed under 37 CFR 1.97 and 37 CFR 1.98 (“Background Art”)

The problems which arise out of transporting a pet in a carrier is that a pet is often curios and does not want to be closed up in a dark enclosing of which it cannot see out. A pet does not want to be shut in on all sides to a dark confined space especially when a confined space prevents the pet from seeing and knowing what is going on around it. A pet naturally becomes restless and stressed and wants to make itself more comfortable or find the freedom to move or escape. A pet wants to be able to know what is going on outside of its dark confined space. As the pet attempts to make itself more comfortable or find the freedom to move or escape, its movements make for a more difficult pet transportation experience for the owner.

The following references generally relate to pet carriers, but none teach of the use of a transparent true dome-shaped porthole window which invites a pet to comfortably place its head and use as a window. Specifically, Skaggs D. 694,961 S1, Chou U.S. Pat. No. 8,459,208 B2, Slawinski U.S. Pat. No. 4,977,857 A, Burns U.S. Pat. No. 6,286,462 B1, Salahor U.S. Pat. No. 6,446,577 B1, Bottorff 2006/0288953 A1, Alves 2009/0205578 A1, Krauss et al. 2010/0175633 A1, and Chang 2011/0056441 A1 do not teach of a transparent true dome-shaped porthole window. Each use a mesh or other type of material to create a window of limited viewing and for purposes of ventilation which is distinguishable from what the present invention teaches.

The present invention teaches the use of a piece of transparent glass, plastic, and/or other suitable transparent material which is molded into the shape of a true dome truncated at its meridianal equator, with a lip on the base which then creates the invention—a transparent true dome-shaped porthole window.

Grabois 2012/0174870 A1 teaches of a fishbowl inserted into a stuffed animal bear. The glass fishbowl is the entire housing and living environment for the fish. The present invention is not meant for a fish and is meant to provide a porthole window that an animal can place its head, not its whole body.

Moreover, the invention is distinguishable from Bryson 2009/0314219. Bryson teaches of two side panels that may be made of a combination of materials. Bryson does not teach of a glass, plastic, or other suitable transparent material dome shaped porthole window. Bryson does not teach of a such a porthole window meant for a pet to place its head.

The invention is distinguishable from the Babson et al. U.S. Pat. No. 8,584,618.

Babson provides the following description and teaching:

“The lid is adaptive to for the top opening (105) of the cage (110). In some embodiments, the lid (210) is transparent or semi-transparent so that a user can view the pet situation inside the cage. . . . In some embodiments, the lid (210) has a bubble shape for more headroom for the pet.

First, Babson does teach of an invention which invites or allows a pet to place its head into a porthole window like the present invention. Babson does not teach nor is it meant to invite the pet to place its head into the lid for the purpose of comfortably and viewing. Babson teaches of a lid that, while a pet may look upward and outward, is not conducive for a pet to place its head or provide as great a degree of viewing as the instant invention. In contrast to Babson, the present invention actually invites a pet to place its head into the porthole window. When being placed in the housing of the carrier apparatus, almost automatically, a pet will place its head into the porthole window. The pet will be able to view a greater degree of what is going on outside the carrier apparatus, while at the same time being more comfortable and protected.

Second, Babson does not teach of a porthole window, but rather of a lid—which makes up a complete side of the pet housing. The present invention teaches of a pet specific porthole window that can be placed accordingly on different containers, and is not necessarily required to make up an entire side of a pet housing for a carrier.

Third, the present invention is meant specifically as a porthole window for a pet, allowing it a greater degree of visibility. The Babson lid allows a pet only to see upwards. It does not allow the degree of visibility as the present invention. To the contrary, the present invention allows for a pet to see 180 degrees. The present invention allows a pet with a greater sightline and visibility. This results in a reduced stress level for a pet and more pleasurable experience for the owner. The purpose of the Babson lid, as described, is to allow, “. . . view the pet situation inside the cage.” The present invention purpose is to allow a pet to observe the situation outside its carrier.

Fourth, the size of the present invention is dependent and varies with the size of a pet. The present invention teaches of a porthole window which is sized slightly larger than the size of a pet's head the user is transporting. Babson, on the other hand, teaches of a lid whose size is dependent on the size of the carrier itself.

Fifth Babson teaches of a led that is devoid of a lip as the present invention. The present invention necessarily has a lip on the base of the true dome in order to allow for its attachment to a carrier. The present invention therefore is more versatile as the size of the carrier and the size of the present invention are not dependent upon one another. Babson teaches of a lid that is necessarily dependent on the size of the carrier, otherwise the Babson lid would not fit or be workable. The present invention is adjustable to the size of a pet's head specifically and not necessarily to the carrier.

### SUMMARY OF THE INVENTION

The present invention solves this problem. The present invention teaches the use of a piece of transparent glass, plastic, and/or other suitable transparent material which is molded into the shape of a true dome truncated at its meridianal equator, with a lip on the base which then creates the invention—a transparent true dome-shaped porthole window. The transparent true dome-shaped porthole window invites a pet to place its head comfortably inside, allows for a greater amount of light to enter the carrier, and provides a greater and more transparent viewing area for the pet.

The result is more content, restful, and less stressed pet which translates to a more pleasant experience for a pet's owner.

The present invention may be utilized in conjunction with totes, bags, backpacks, duffels, luggages or the like. The transparent true dome-shaped object acts as a porthole window for a pet during transportation. It invites a pet to comfortably place its head inside and allows a greater amount of light to enter the transportation carrier. It allows the pet to transparently see out of the carrier to a greater degree than other present inventions while also providing greater protection against harm or damage to a pet's face.

The invention contemplates the use of a transparent true dome-shaped object with an outwardly directed lip on its base. The outwardly directed lip allows for the dome to be attached to a pet carrier at different optimal locations which maximize a pet's comfort and visibility dependent upon the size and/or shape of the carrier. The transparent true dome-shaped porthole window may be attached to a carrier by means of stitch, adhesion, mounting, or fastening. The lip is attached to the inside of a circular cut-out in a carrier which is just slightly greater than the circumference of the dome to insure a tight fit. When properly installed into totes, bags, backpacks, duffels, luggages, or the like the transparent true dome-shaped porthole windows allows for a pet to comfortably place its head inside and look out. The transparent true dome-shaped porthole window allows for light to enter a carrier. The transparent true dome shaped porthole window provides for increased comfort and visibility for a pet during transportation and ultimately a more pleasant experience for the pet as well.

Once the pet is in the pet carrier, it will generally automatically put its head in the space provided by the transparent dome-shaped porthole window.

### DRAWINGS

(A) Figures

FIG. 1 is a three-dimensional view of a transparent true dome-shaped porthole window as contemplated in a first apparatus as it may appear in a pet carriage, duffle, luggage carry-on, tote or otherwise similar container.

FIG. 2 is a three-dimensional view of a transparent true dome-shaped porthole window as contemplated in a first apparatus, and having an outwardly directed lip as it would appear prior to installation through means of stitch, adhesion, mounting, or fastening.

FIG. 3 is a two-dimensional side-view of a transparent true dome-shaped porthole window as contemplated in a first apparatus as it may appear in a pet carriage, duffle, luggage carry-on, tote or otherwise similar container with a three-dimensional view of the handle and or strap.

FIG. 4 is a two-dimensional front-view of a transparent true dome-shaped porthole window as contemplated in a first apparatus as it may appear in a pet carriage, duffle, luggage carry-on, tote or otherwise similar container with a three-dimensional view of the handle and or strap.

FIG. 5 is a three-dimensional view of a transparent true dome-shaped porthole window as contemplated in a second apparatus as it may appear in a pet carriage, backpack, knapsack, pack, luggage, carry-on, tote, or otherwise similar container.

FIG. 6 is a two-dimensional side-view of a transparent true dome-shaped porthole window as contemplated in a second apparatus as it may appear in a pet carriage, backpack, knapsack, pack, luggage, carry-on, tote, or otherwise similar container.

FIG. 7 is a two-dimensional front-view of a transparent true dome-shaped porthole window as contemplated in a second apparatus as it may appear in a pet carriage, backpack, knapsack, pack, luggage, carry-on, tote, or otherwise similar container.

FIG. 8 is a three-dimensional view of a transparent true dome-shaped porthole window as contemplated in a third apparatus as it may appear in a pet carriage, rolling luggage, rolling suitcase, luggage, suitcase, valise or otherwise similar container.

FIG. 9 is a two-dimensional side-view of a transparent true dome-shaped porthole window as contemplated in a third apparatus as it may appear in a pet carriage, rolling luggage, rolling suitcase, luggage, suitcase, valise or otherwise similar container as may appear should said container be standing upright.

FIG. 10 is a two-dimensional side-view of a transparent true dome-shaped porthole window as contemplated in a third apparatus as it may appear in a pet carriage, rolling luggage, rolling suitcase, luggage, suitcase, valise or otherwise similar container as may appear should said container be placed laying down.

FIG. 11 is a two-dimensional front-view of a transparent true dome-shaped porthole window as contemplated in a third apparatus as it may appear in a pet carriage, rolling luggage, rolling suitcase, luggage, suitcase, valise or otherwise similar container as may appear should said container be standing upright.

### (B) REFERENCE NUMERALS

1 transparent dome-shaped porthole window
2 base of dome-shaped porthole window
3 outwardly directed lip
4 circular cut-out in a carrier which is just slightly greater than the circumference of the dome

### DETAILED DESCRIPTION OF INVENTION

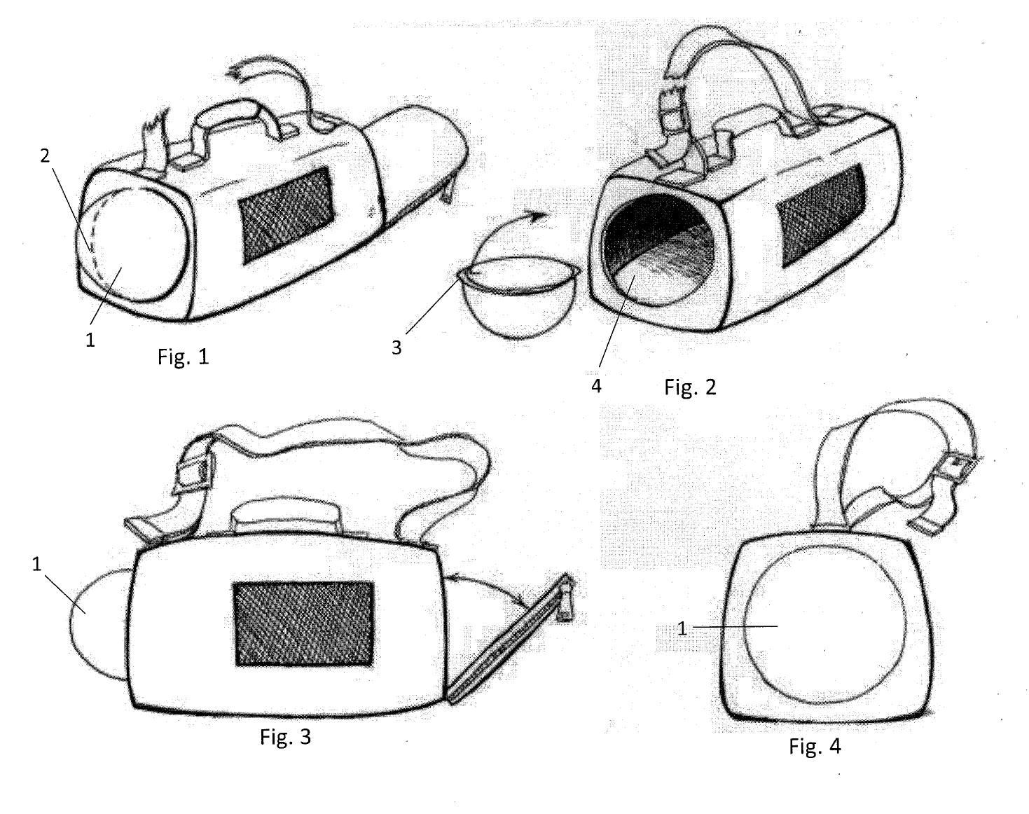

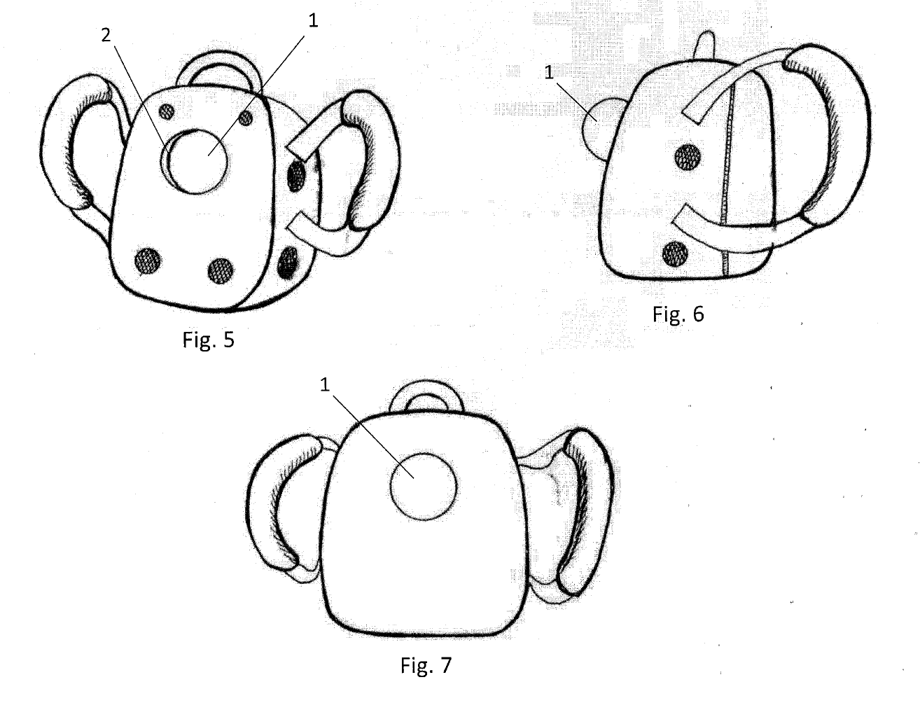

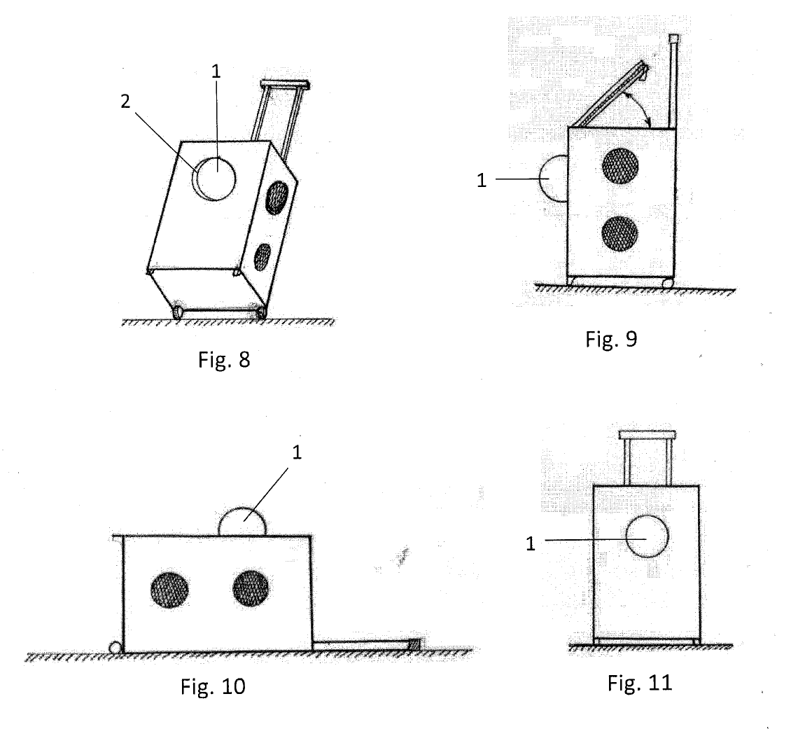

A transparent true dome-shaped porthole window for pets during transportation that allows space for a pets head and viewing is illustrated as contemplated in three (3) separate apparatuses in FIG. 1, FIG. 3, FIG. 4, FIG. 5, FIG. 6, FIG. 7, FIG. 8, FIG. 9, FIG. 10. The transparent true dome-shaped porthole window 1 is made of a piece of glass, plastic, and/or other suitable transparent material molded into the shape of a true dome. The transparent true dome-shaped porthole window acts to allow the pet to place its head inside the porthole window, light to enter the container, allows the pet to see out of the container, protects the pets face from harm or damage, and allows for increased comfort and ergonomically correct pet transportation.

The transparent true dome-shaped porthole window is truncated at the meridian equator so as to be divided in one-half 2 and create the base for the dome.

The transparent true dome-shaped porthole window is attached at the lip 3 to an apparatus through means of stitch, adhesion, mounting, or fastening. The lip 3 is affixed to the inside of the corresponding container where the corresponding container has a circular cut-out equivalent to the inner circumference of the transparent spherical shaped object 4.

The transparent true dome-shaped porthole window may be fitted and installed into a pet carriage or container including a duffle, luggage carry-on, tote or otherwise similar container as illustrated in FIG. 1, FIG. 3, FIG. 4, a backpack, knapsack, pack, luggage, carry-on, tote, or otherwise similar container as illustrated in FIG. 5, FIG. 6, FIG. 7, and/or a rolling luggage, rolling suitcase, luggage, suitcase, valise or otherwise similar container as illustrated in FIG. 8, FIG. 9, FIG. 10.

1. A pet carrier comprising:
a clear geometrically shaped window, such as but not limited to a cylindrical, oval, crescent, rectangular, square, and/or spherical globe-shaped object, which acts as a porthole for a pet during transportation, allows space for the pets head, allows light to enter. and allow the pet to see out;
a container which the above mentioned window is affixed to;
the rabbet edge of the above mentioned window is affixed to the container through means of stitch, adhesion, mounting, fastening, or otherwise.

2. The pet carrier of claim 1 wherein the geometrical object has an outwardly directed rabbet edge on the meridianal equator.

3. The pet carrier of claim I wherein said body of the geometrical object is a hard plastic, glass, or combination of glass and plastic.
